(19) United States
(12) Patent Application Publication
(10) Pub. No.: US 2015/0160835 A1
(43) Pub. Date: Jun. 11, 2015

(54) Pluggable Layouts for Data Visualization Components

(71) Applicant: ORACLE INTERNATIONAL CORPORATION, Redwood Shores, CA (US)

(72) Inventors: Prashant Singh, Lexington, MA (US); Brendon Glazer, Billerica, MA (US); Jairam Ramanathan, Waltham, MA (US); Lory Molesky, Lexington, MA (US)

(73) Assignee: ORACLE INTERNATIONAL CORPORATION, Redwood Shores, CA (US)

(21) Appl. No.: 14/514,217

(22) Filed: Oct. 14, 2014

Related U.S. Application Data
(60) Provisional application No. 61/914,208, filed on Dec. 10, 2013.

(51) Int. Cl. G06F 3/0484; H04L 12/24

(52) U.S. Cl. CPC G06F 3/04842; H04L 41/22; H04L 41/12

(57) ABSTRACT

Various arrangements are presented that allow for a prebuilt visualization component to be incorporated into an application under development, wherein the prebuilt visualization component is configured to create graphical nodes to be arranged and output for presentation by the application following compilation. A layout plug-in may be registered with the prebuilt visualization component such that the prebuilt visualization component communicates with the layout plug-in. The layout plug-in may be configured to arrange the graphical nodes such that the graphical nodes created by the prebuilt software component are arranged by the layout plug-in following compilation. The application may be compiled such that the application is compiled to include the prebuilt visualization component and the registered layout plug-in.

### CROSS REFERENCE TO RELATED APPLICATION

This application claims priority to U.S. Provisional Application No. 61/914,208, filed Dec. 10, 2013, attorney docket number 88325-890597 (147701US), which is hereby incorporated by reference for all purposes.

### BACKGROUND

Visual representations of data can make understanding large and/or complicated data sets much easier for a person. Varying types of data lends itself to representation in different forms. Further, depending on the situation, a certain customized data layout, such as a specific layout arrangement for an organizational chart, may be desired for visualizing data. As such, an increase in the ability to customize data visualizations may benefit users.

### SUMMARY

Embodiments detailed herein relate to incorporating data visualization capabilities into an application and executing such applications. Such embodiments may be implemented as computerized system, methods, apparatuses, and non-transitory computer-readable mediums. In some embodiments, a prebuilt visualization component may be incorporated into an application under development, wherein the prebuilt visualization component is configured to create graphical nodes to be arranged and output for presentation by the application following compilation. A layout plug-in may be registered with the prebuilt visualization component such that the prebuilt visualization component communicates with the layout plug-in. The layout plug-in may be configured to arrange the graphical nodes such that the graphical nodes created by the prebuilt software component are arranged by the layout plug-in following compilation. The application may be compiled such that the application is compiled to include the prebuilt visualization component and the registered layout plug-in.

Such arrangements may include one or more of the following features: The application may be executed after compilation using the same or a different computer system. The application may receive data to be visualized. The prebuilt visualization component being executed by the computer system as part of the application may create a plurality of graphical nodes based on the data. The layout plug-in being executed by the computer system as part of the application may determine a plurality of locations for the plurality of graphical nodes. The layout plug-in being executed by the computer system may provide to the prebuilt visualization component, a set of coordinates indicative of the plurality of locations for the plurality of graphical nodes. The application being executed by the computer system may output to a presentation device, a data visualization representing the data as the plurality of graphical nodes arranged based on the plurality of locations. The prebuilt visualization component being executed by the computer system may provide to the layout plug-in, characteristic information for each node of the plurality of graphical nodes. The layout plug-in being executed by the computer system as part of the application may arrange a plurality of edges, wherein each edge connects at least two graphical nodes of the plurality of graphical nodes. The application being executed by the computer system may receive a selection of a graphical layout style. The graphical layout style selected may correspond to the layout plug-in. The layout plug-in may be used to determine the location of graphical nodes at least partially based on the section of the graphical layout style.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1A illustrates an embodiment of a data visualization system that uses a layout plug-in for creating data visualizations.

FIG. 1B illustrates an embodiment of a data visualization system incorporated as part of an application under development.

FIG. 2 illustrates an embodiment of a data visualization system configured to use registered layout plug-ins for creating data visualizations.

FIG. 3 illustrates an embodiment of a layout plug-in configured to be registered for use in a data visualization system.

FIG. 4A illustrates an embodiment of a tree data visualization having graphical nodes and edges arranged based on a layout plug-in used by a data visualization system.

FIG. 4B illustrates an embodiment of a grid data visualization having graphical nodes and edges arranged based on a layout plug-in used by a data visualization system.

FIG. 4C illustrates an embodiment of a bus data visualization having graphical nodes and edges arranged based on a layout plug-in used by a data visualization system.

FIG. 4D illustrates an embodiment of an arc data visualization having graphical nodes and edges arranged based on a layout plug-in used by a data visualization system.

FIG. 4E illustrates an embodiment of a container data visualization having graphical nodes and edges arranged based on a layout plug-in used by a data visualization system.

FIG. 4F illustrates an embodiment of a circle data visualization having graphical nodes and edges arranged based on a layout plug-in used by a data visualization system.

FIG. 5 illustrates an embodiment of a method for using a layout plug-in as part of a data visualization system.

FIG. 6 illustrates another embodiment of a method for using a layout plug-in as part of a data visualization system.

FIG. 7 illustrates an embodiment of a distributed system that permits the use of a data visualization system.

FIG. 8 illustrates an embodiment of a system environment by which services may be offered as cloud services.

FIG. 9 illustrates an embodiment of a computer system, which may be used to implement various embodiments detailed herein.

### DETAILED DESCRIPTION

Data visualization software components, which can be incorporated as part of an application such as during development, are typically configured to present data in various predefined layouts. Such predefined layouts may be acceptable if one of the predefined layouts represents a desirable layout for how a developer desires data to be visualized to an end user. However, if a layout is desired that the data visualization software component does not possess, the developer may have limited options. For instance, the developer may typically be forced to wait unit a future release of the data visualization software contains the preconfigured layout desired to be used to present data to an the user.

Rather than having a data visualization software component have only a set of preconfigured layouts available for arranging graphical representations of data, the data visualization software may be configured to accept layout plug-ins. As such, data accessed by an end user may be presented to the end user in the format defined by the layout plug-in. Layout plug-ins can be registered with a data visualization software component (such as during development of a software package that includes the data visualization software component) without a new build of the data visualization software component being needed. A layout plug-in may communicate with the data visualization software component via a layout application programming interface (API) of the data visualization software component. The layout plug-in may handle only specific tasks, such as determining the location of where nodes are to be graphically presented and the location of links (also referred to as edges) between nodes (and/or other graphical objects). Therefore, a developer may use a separate layout plug-in or may develop one himself to allow the data visualization software component to output a visualization of data to an end user, the data being presented as desired by the developer. The data visualization software component may be incorporated as part of larger application being developed. As such, the data visualization output for presentation to a user may occur as part of an application created by the developer. For instance, the data visualization software component may be incorporated as part of a Java™ application developed using Oracle's® JDeveloper. More generally, the data visualization software component may be understood as a developing environment that allows a user to program using a programming language by using various prebuilt software components.

As an example of this, a developer may develop a web-based Java™ application for use by end users. To create the web-based application, various precoded software components may be implemented by the developer to perform various functions of the web-based application. One of these components may be a data visualization software component that is used to output a data visualization to an end user of the web-based application. This data visualization software component may serve to visually represent data accessed by or acquired from the end user. In order to visualize the data in a format desired by the developer (and, likely, the end user), the developer may configure the data visualization component to access a layout plug-in that defines how such data is to be laid out and connected via edges.

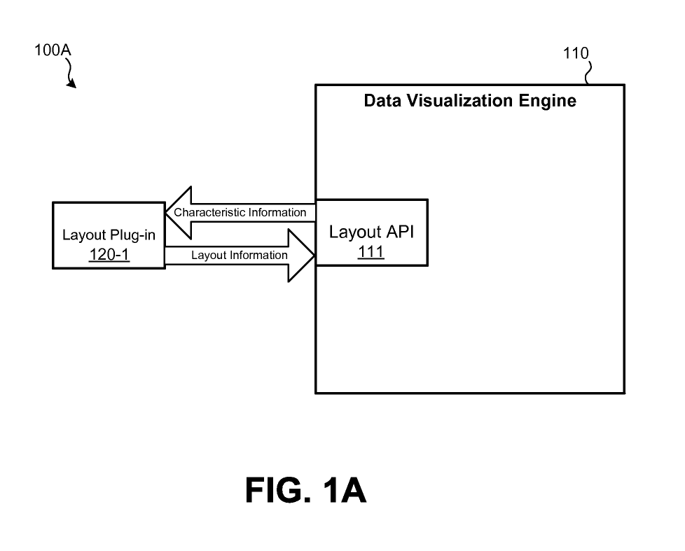

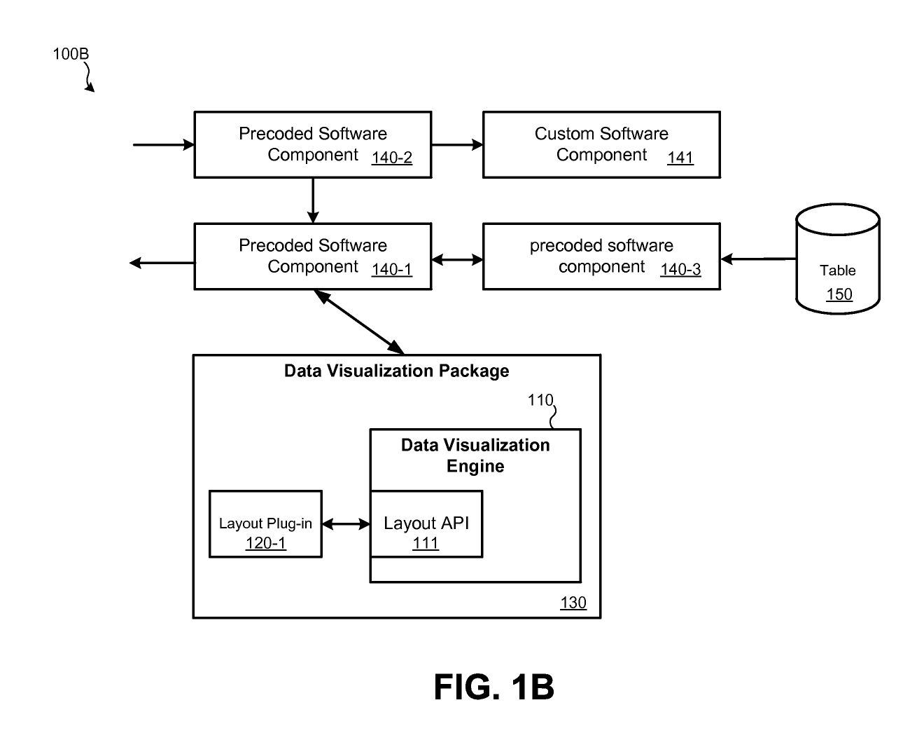

FIG. 1A illustrates an embodiment of a data visualization system 100A configured to use layout plug-ins. Data visualization system 100A may be composed of multiple pieces of software that are executed using computerized hardware, such as one or more computer systems, one or more servers, etc. In some embodiments, data visualization system 100A is implemented via the cloud; that is, a developer may, via a client computer system, may access a developing environment executed by a remote server accessible via a network, such as the Internet. At this remote server, the developer may create and implement code for execution in the form of an application via the developing environment. Code developed and configured by the developer may be created, at least partially, using predefined code components that permit particular functionality, such as data visualization. For instance, such an arrangement may permit a developer to create a Java™ application in the cloud using a product, such as Oracle's® JDeveloper or some other cloud-based application development platform.

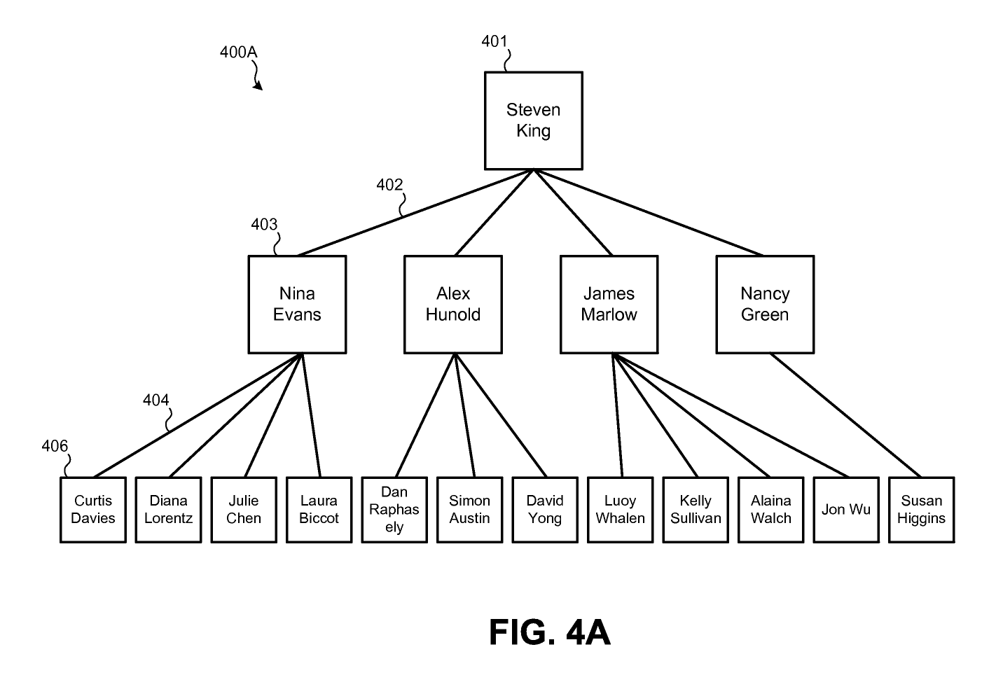

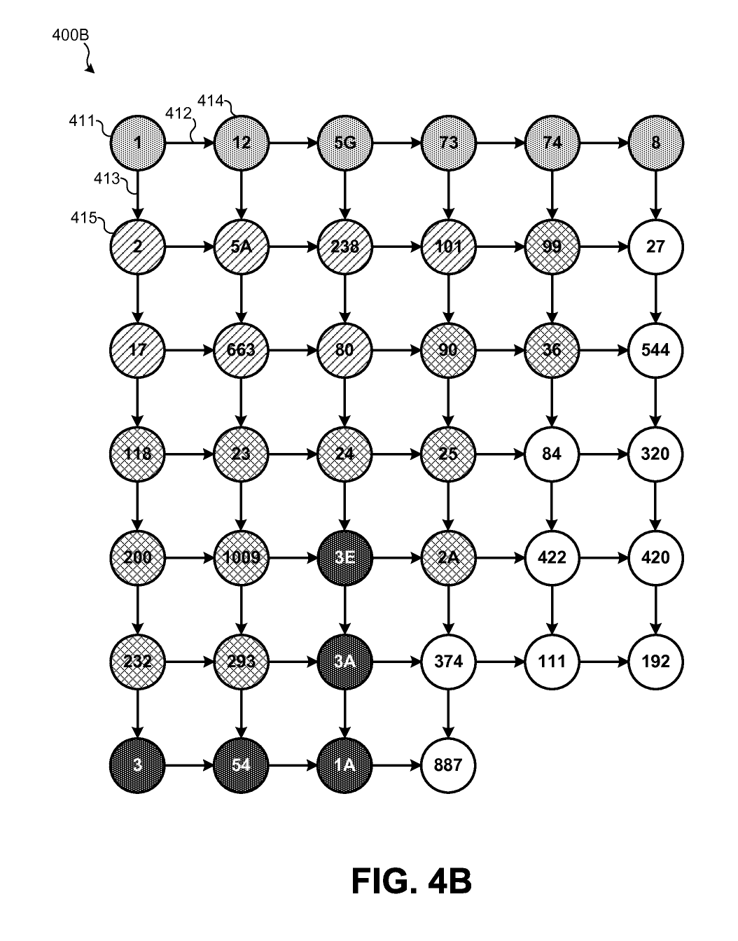

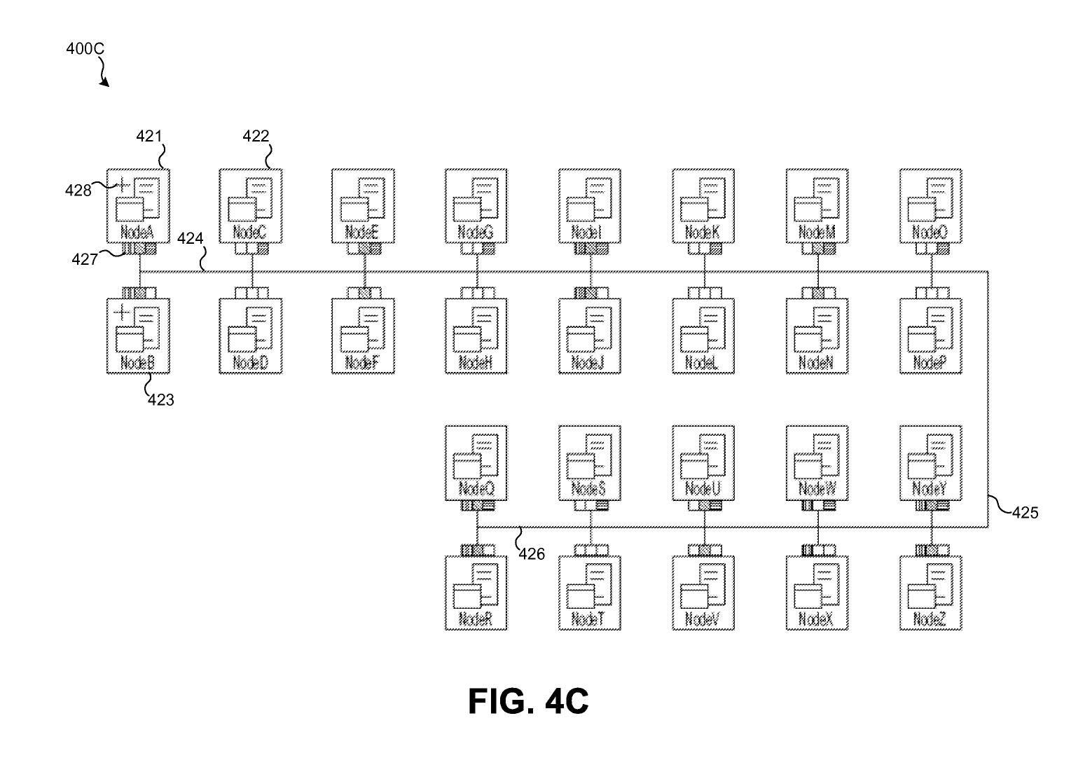

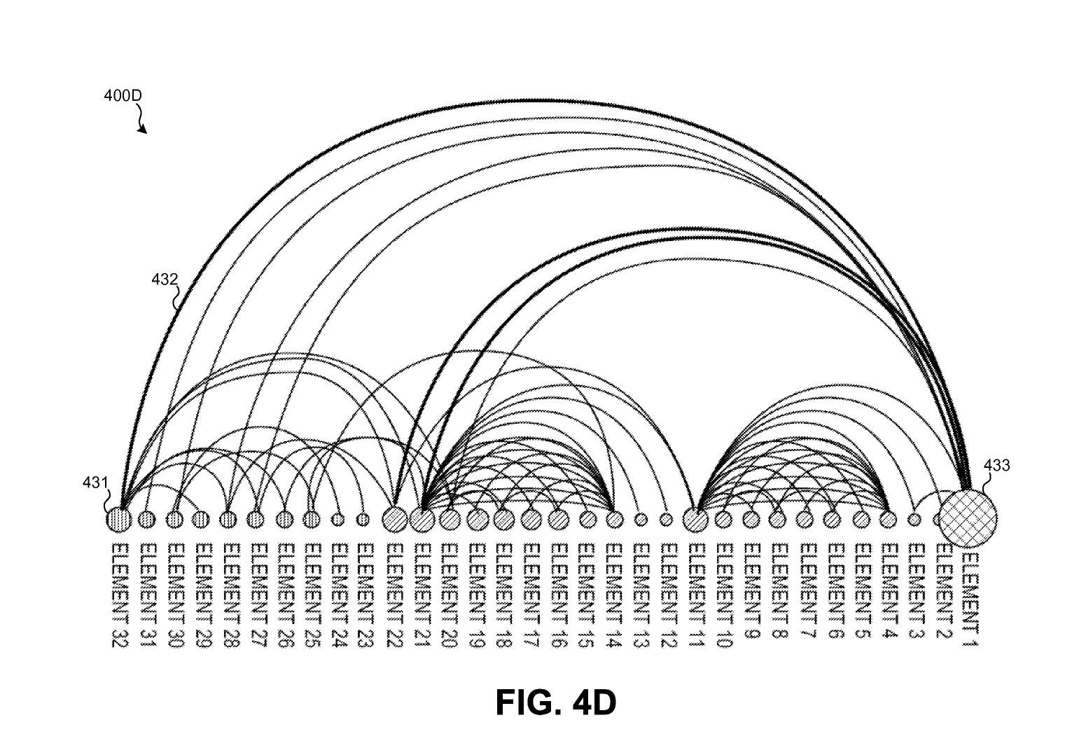

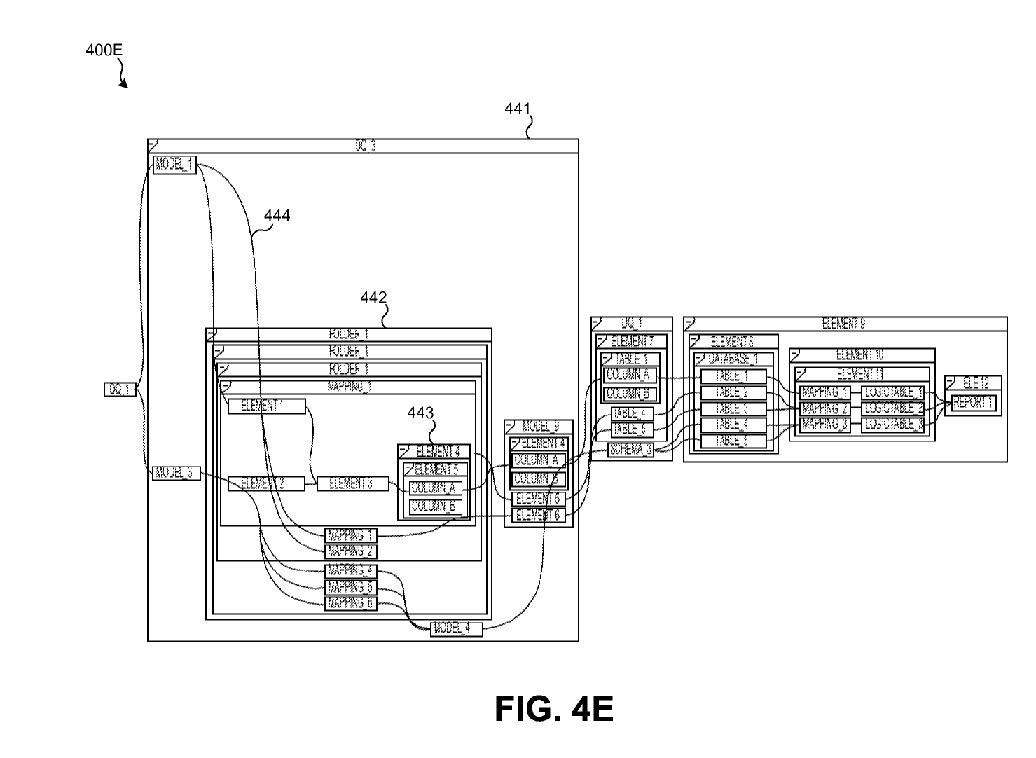

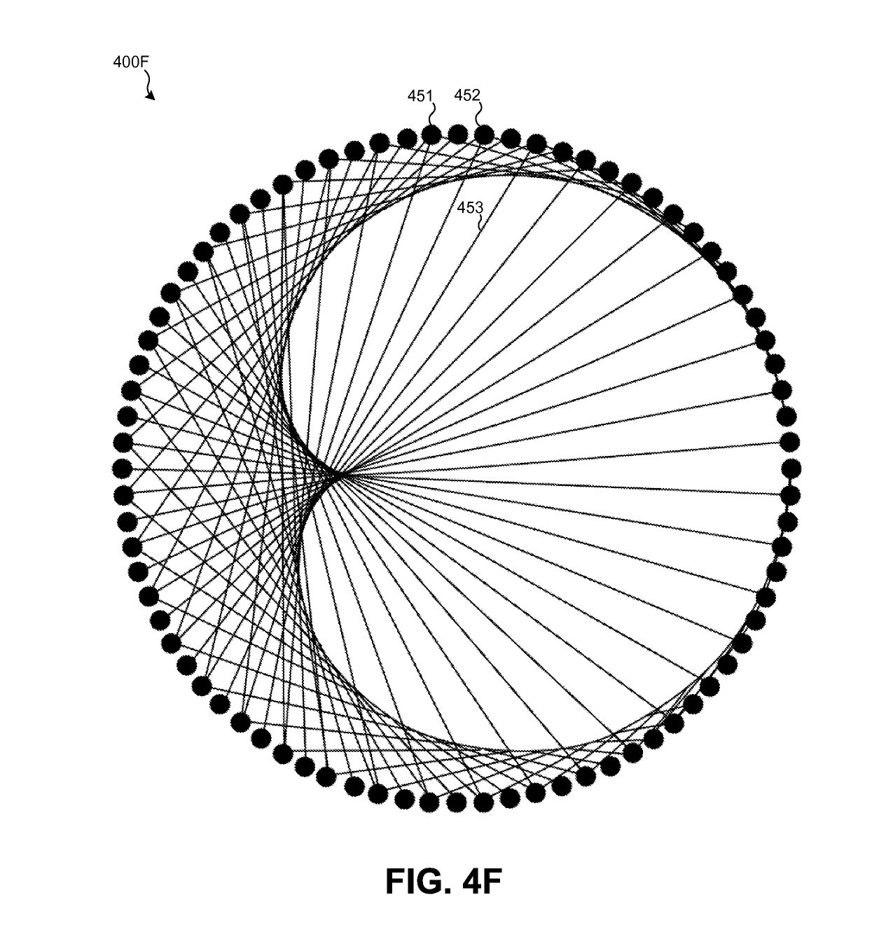

Data visualization system 100A includes: data visualization engine 110, layout API 111, and layout plug-in 120-1. Data visualization engine 110 represents a data visualization software component that may be incorporated as part of an application under development. Data visualization engine 110 may be a code component that a developer can implement as part of an application that the developer is creating, such as illustrated in FIG. 1B. Data visualization engine 110 may be incorporated as a prebuilt code component in the code of an application under development. Data visualization engine 110 may allow for data to be output for presentation, such as to a display device, in a graphical format that facilitates user understanding of the data. For instance, data visualization engine 110 may be used to create organizational charts, hierarchies, bar graphs, etc. Examples of data visualizations are provided in relation to FIGS. 4A-4F.

When provided with data to be output for presentation, data visualization engine 110 may perform the majority of functions as compared to a layout plug-in. Data visualization engine 110 may determine how each graphical node (which represents the data) and edge will be represented, such as size, text, shading, borders, graphics, and/or coloring. Data visualization engine 110 may also permit a user to interaction with graphical nodes, such as by “drilling” into the data associated with graphical nodes based on user input, thus allowing for additional information (or less information) to be output for presentation. Data visualization engine 110 may perform all functions of formatting data for visual presentation except for how graphical nodes and edges are laid out for presentation. A layout plug-in may be configured to determine where each graphical node should be located for presentation and/or where edges (which may connect two or more graphical nodes) should be located.

Data visualization engine 110 may include a layout application programming interface (API) 111. Layout API 111 may be configured to output information to layout plug-ins that provides the layout API 111 with characteristic information about each graphical node and which graphical nodes are to be linked together via an edge. Characteristic information may represent at least some of the underlying data on which the graphical nodes are based. For instance, characteristic information may indicate the relationships among the data of the graphical nodes, the size of the graphical nodes, etc. There are three levels of information that may be provided, including: 1) global, 2) node, and 3) link. Global information may include: a name of the layout; custom application-defined layout attributes; a list of nodes to layout; a list of links to layout; an indication of whether the locale has a left-to-right or right-to-left reading direction; a width and/or height of the data visualization component; the current viewport rectangle onto the displayed nodes and links; an identifier of the container that contains the nodes and links currently being laid out (for example, when the layout is being done on the contents of a nested container); and padding to add to the container that contains the nodes and links currently being laid out (for example, when the layout is being done on the contents of a nested container). Node information may include: an identifier of each node, an outer width and/or height of each node (including decorative overlays), a width and/or height of the node content proper (excluding decorative overlays), a width and/or height of the node label; custom application-defined node layout attributes; an indication of whether a node can be positioned during this layout call (for example, a node might have already been positioned, but may be provided again as context for purposes of link routing); an identifier of the container that each node belongs to; an indication of whether the node is selected; the padding applied to this node if it is a container; and an indication of whether the node is disclosed if it is a container. Link information may include: an identifier of the link; an identifier of the start node; an identifier of the end node; a width and/or height of the link label; an offset to leave between the link start and the start node for a connector to be drawn; an offset to leave between the link end and the end node for a connector to be drawn; a thickness of the link; custom application-defined link layout attributes; an indication of whether the link is selected, and an indication of whether the link is promoted (for example, if a link connects to a node inside a closed container, that link can be promoted to the container so that it appears to connect to the container itself when closed). Layout API 111 may provide such characteristic information to a layout plug-in in a standardized format.

The current viewport rectangle onto the displayed nodes and links refers to how the links and nodes are viewed using zooming and panning in a virtual coordinate space. The displayed nodes and links can be laid out in a virtual coordinate space. The data visualization component provides a “viewport” onto that coordinate space. That viewport may be zoomed in and out and panned around in the virtual coordinate space. For example, if nodes and links are arranged in a square grid that spans x and y coordinates from 0 to 1000, but the data visualization component is physically only 500 pixels by 500 pixels on the screen, then the viewport needs to be zoomed out to a 0.5 scale in order for the user to see all of the nodes and links when graphically presented. The user may zoom in to a scale of 1.0 and pan to some location within the virtual coordinate space in order to get a better view of some of the nodes and links. The “current viewport rectangle” referred to is the mapping of the physical viewport of the data visualization component onto the virtual coordinate space occupied by the nodes and links.

“Padding,” as referred to above, is additional space to include in a container around its contained nodes and links so that the outside edges of the container do not touch contained nodes and links For example, if the nodes and links in a container occupy a square space from 0 to 1000 pixels, and the container has 100 pixels padding on each side, then the container size would actually be 1200px by 1200px, with 100 pixels of empty space between each of the container's edges and the contents of nodes and links. Without a defined amount of padding, a container would usually be large enough to accommodate only the nodes and links laid out within it with the edges of the container touching the outer nodes and links that define the container's size.

Layout plug-in 120-1 may receive the characteristic information about the graphical nodes and/or links between graphical nodes from layout API 111 of data visualization engine 110. Layout plug-in 120-1 may be a predefined code component that can be registered with data visualization engine 110 and incorporated as part of an application being developed by a developer. As such, to be used as part of the application under development, both data visualization engine 110 and layout plug-in 120-1 may be incorporated as part of the code of the application, such as presented in FIG. 1B. Layout plug-in 120-1 may analyze the characteristic information and return location data, such as in the form of coordinates, that indicates where each graphical node is to be located and/or the path of links between two or more graphical nodes. Each link may include multiple sets of coordinates that defines the path of the link and/or other information that may define the link, such as a radius and center point to draw an arc for the path. Such location information is output to layout API 111 as layout information and can then be used by data visualization engine 110.

Layout API 111 may receive this layout information from layout plug-in 120-1 and use the received layout information to create the graphical representation of the data for output for presentation. Within the application created by the developer, both data visualization engine 110 along with layout plug-in 120-1 may be implemented, such that when compiled and executed by a user, data will be output for presentation in a layout dictated by layout plug-in 120-1. As such, when incorporated into and executed as part of an application, data visualization engine 110 will output data for presentation in accordance with a layout dictated by layout plug-in 120-1.

FIG. 1B illustrates an embodiment of an application 100B under development that has an incorporated data visualization system. Application 100B can represent an application being developed by an application developer. Such an application may be developed locally, such as on the computer system being used by the developer or remotely. In a remote situation, the developer may interact with a remote server which compiles and debugs code. The developer may interact with the remote server via a computerized device and one or more networks, such as a tablet computer or desktop computer.

Application 100B may be under development and may be composed of one or more precoded software components and/or one or more custom software components. Precoded software components 140 may represent precoded software components to which the developer has access. Such precoded software components 140 (which in FIG. 1B includes 140-1, 140-2, and 140-3) may be made available via the development environment that the developer is using to create application 100B. The developer may further configure precoded software components 140 to execute and interact as desired by the developer. Custom software component 141 may represent a piece of code developed from scratch by the developer, which can interact with precoded software components 140. In addition to preconfigured and custom software components being present in the application, data structures, such as table 150 may be either directly incorporated into the application and/or may be accessible by the application.

One of such precoded software components may be data visualization package 130, which can represent data visualization system 100A of FIG. 1A. Data visualization package 130 may include data visualization engine 110 and one or more layout plug-ins, such as layout plug-in 120-1. The developer may register layout plug-in 120-1 with data visualization engine 110 such that data received from precoded software component 140-1 (or some other source) can be graphically represented in accordance with a layout defined by layout plug-in 120-1. When the code for application 100B is compiled, data visualization package 130 may be incorporated as part of the compiled, executable code. Such code may then be executed by an end user's computer system or on behalf of an end user, such as in the form of a cloud-based application that is executed by a remote server.

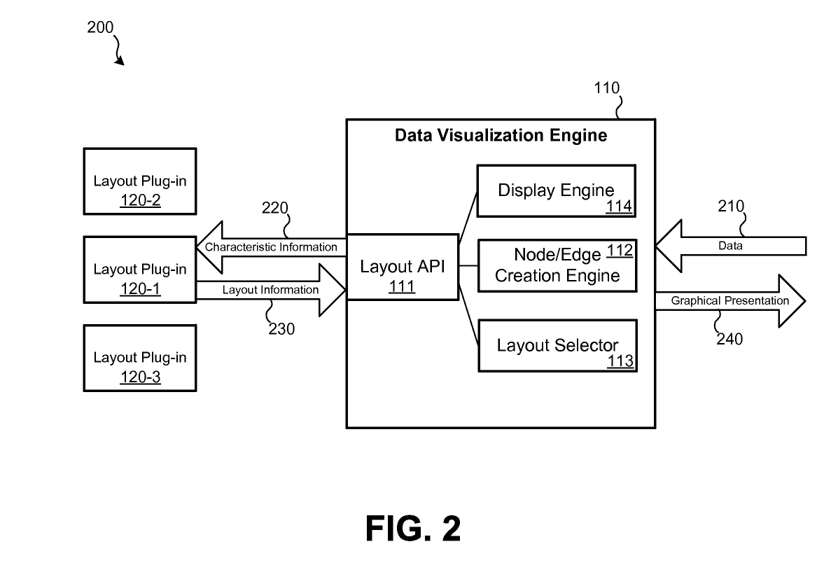

FIG. 2 illustrates an embodiment of a data visualization system 200 configured to use registered layout plug-ins. Data visualization system 200 may be a more detailed embodiment of data visualization system 100A of FIG. 1A. A developer may incorporate data visualization engine 110 along with one or more desired layout plug-ins 120 into an application that the developer is developing. For instance, an integrated development environment (IDE), which may be used by a developer via the cloud, may be used to create an application using one or more programming languages, such as Oracle's® Java™.

Data visualization engine 110 may include multiple components, each of which may be implemented using software, firmware, and/or computerized hardware. Data visualization engine 110 may be part of a predefined code component that is configured to be incorporated into an application being developed using a programming language. Data visualization engine 110 may include: layout API 111, node/edge creation engine 112, layout selector 113, and display engine 114. Data visualization engine 110 may be configured to receive data 210 when executed as part of an application into which it has been integrated. Data 210 may include multiple pieces of information which can be represented as nodes and edges in a visual format. For instance data 210 may include multiple data points that have interrelationships and may be at least partially pulled from a database or other data storage arrangement in communication with data visualization engine 110. Further, data 210 may include an indication of the relationships between pieces of data, such as in the form of a list of interrelationships between two or more nodes, indications of families of nodes, etc.

Node/edge creation engine 112 may create a plurality of graphical nodes based on data 210. Node/edge creation engine 112 may also create the graphical representations of edges. Node/edge creation engine 112 may determine the size, text, color, and/or shape of nodes to be presented to a user of the application. Layout selector 113 may permit developer to register one or more layout plug-ins 120. Data visualization engine 110 may include one or more predefined layouts for presenting graphical nodes representative of data. However, a developer may register one or more additional layouts via layout plug-ins 120. Each of layout plug-ins 120 may define layouts for nodes and edges between nodes that are not defined in one or more predefined layouts of data visualization engine 110. When the developer is incorporating data visualization engine 110 into an application under development, the developer may specify via layout selector 113 a layout plug-in to be used to determine the layout of graphical representations of data 210.

As detailed in relation to FIG. 1, layout API 111 of data visualization engine 110 may transmit characteristic information 220 to layout plug-in 120-1. Layout plug-in 120-1 may have been specified by developer via layout selector 113 through which layout plug-in 120-1 was registered with the data visualization engine 110. Characteristic information 220 may include at least a subset of data 210. More specifically, characteristic information may include: a size for each node; children nodes (for a node that is an expanded group), chrome size (for a node that is an expanded group), connection anchors of nodes, layout-specific information (e.g., sparse grid position, and/or custom application information. Regarding links (edges), characteristic information may include: an indication of a source node for each link, an indication of a destination node for each link, a style for each link (e.g., direct, orthogonal, etc.), a label size, a relative label position (where the label should be placed along the link), a type of link (e.g., direct, orthogonal, curved, etc.), and/or custom application information. Characteristic information may also include layout-specific options, such as a direction (e.g., left to right, top to bottom), and/or an indication of whether grid columns and rows should be uniform in size).

Characteristic information 220 may be used by layout plug-in 120-1 to determine the location of where graphical nodes are to be presented and the location of links between graphical nodes to be presented. This may be the only information returned by layout plug-in 120-1 to layout API 111. Therefore, layout information 230 may only include information about where a particular graphical nodes are to be presented and where the links associated with those graphical nodes are to be presented. More specifically, layout information may include: pixel positions for each node, pixel positions of segments of links, pixel positions of control points of links, and/or pixel positions of labels. The pixel positions may be in the form of coordinates or relative to a node or link.

Layout API 111 may receive layout information 230 which may be passed to display engine 114. Display engine 114 may arrange the graphical nodes and relationships determined by node/edge creation engine 112 in accordance with the layout information provided by layout plug-in 120-1. When the application that contains data visualization engine 110 and layout plug-in 120-1 is executed, graphical presentation 240 may be output for display to a user based on the nodes created by node/edge creation engine 112 in accordance with the layout indicated by layout plug-in 120-1. Layout plug-ins 120-2 and 120-3 may represent other layout plug-ins which have also been registered by the developer with data visualization engine 110 and which may be used in other situations (e.g., the user selects that data be visualized differently). For example, layout plug-in 120-2 may be accessed by data visualization engine 110 via layout API 111 when the user has indicated that an alternate visual presentation of data 210 is to be output for presentation. As such, multiple layout plug-ins 120 may be registered with data visualization engine 110 during creation and development of an application into which layout plug-ins 120 and data visualization engine 110 are incorporated.

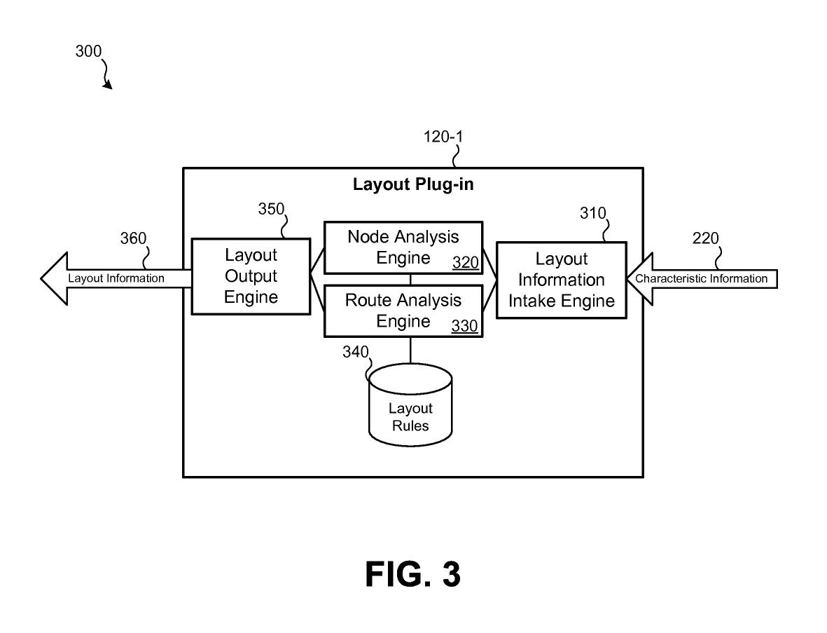

FIG. 3 illustrates an embodiment 300 of a layout plug-in configured to be registered for use in a data visualization system. Embodiment 300 may represent layout plug-in 120-1 of FIGS. 1A, 1B, and/or 2. As previously detailed, layout plug-in 120-1 and may be registered with a data visualization engine and incorporated as part of an application being developed. Layout plug-in 120-1 may include multiple components, each of which may be implemented using software, firmware, and/or computerized hardware. Layout plug-in 120-1 may include: layout information intake engine 310, node analysis engine 320, route analysis engine 330, layout rules 340, and layout output engine 350.

Characteristic information 220 may be received by layout information intake engine 310. Layout information intake engine 310 may be configured to receive data in a format dictated by layout API 111 (e.g., of FIGS. 1 and 2). Layout information intake engine 310 may reformat the received characteristic information 220 into a format appropriate for node analysis engine 320 and/or route analysis engine 330 to use. Node analysis engine 320 may analyze the formatted characteristic information to determine where graphical nodes should be located for presentation. In some embodiments, node analysis engine 320 may determine coordinates for each node. In other embodiments, node analysis engine 320 may determine placement of nodes relative to one or more other nodes and/or links. Similarly, route analysis engine 330 may determine where links between nodes should be located. Characteristic information 220 may indicate the relationship between nodes; therefore, based on characteristic information 220 indicating that two or more nodes are related, route analysis engine 330 may determine where a link between such nodes should be located for display. In some embodiments, route analysis engine 330 may determine one or more sets of coordinates for each link. In other embodiments, route analysis engine 330 may determine relative placement of links relative to one or more other nodes and/or links.

Node analysis engine 320 and/or route analysis engine 330 may determine locations based on one or more defined layout rules 340. Layout rules 340 may be defined by a developer that created layout plug-in 120-1. To be clear, such a developer may be the same developer programming the application or may represent some other developer that has made the layout plug-in 120-1 available. These rules may specify how nodes and links should be positioned in relation to each other. For instance, layout rules 340 may define where a parent node should be positioned in relation to children nodes.

Layout output engine 350 may receive location information from node analysis engine 320 and route analysis engine 330. Layout output engine 350 may format the location information into a format appropriate to be provided to layout API 111. Layout output engine 350 may output layout information 360, which indicates the location is determined by node analysis engine 320 and route analysis engine 330, to layout API 111 of data visualization engine 110.

FIGS. 4A-4F illustrate various visual representations of data and how graphical nodes and links (edges) between such nodes may be arranged by a layout plug-in. The systems and methods of FIGS. 1-3 may be used to create the visual representations of FIGS. 4A-4F. For instance, FIG. 4A illustrates an organization's management structure chart in the form of organizational chart 400A. Each node represents a person, with links between persons to represent management responsibility. Referring to FIG. 2, data visualization engine 110 may generate each graphical representation of the nodes, including nodes 401, 403, 406, and 407. Creation of each node may include creating the size of each node, the color of each node, the text, text size, and font of each node.

Referring again to FIG. 2, layout plug-in 120-1 may determine where each node, including nodes 401, 403, 406, and 407 should be located when output for presentation. Layout plug-in 120-1 may take into account the relationship between the nodes. For instance, the person of node 403 is the manager of the person associated with node 406. Layout plug-in 120-1 may also determine routing for edges that illustrate the relationships between nodes. For instance, layout plug-in 120-1 may determine how edge 402 should be arranged to show the relationship between node 401 and node 403. The layout determined by layout plug-in 120-1 may then be used to present the nodes and edges to a user in the form illustrated in FIG. 4A.

FIG. 4B illustrates a grid chart 400B with each graphical node representing, for example, a process that can be executed. Referring to FIG. 2, data visualization engine 110 may graphical create each node, including nodes 411, 414, and 415. Creation of each node may include creating the size of each node, the color of each node, the text, text size, and font of each node. In FIG. 4B, different patterns are used to represent different colors. Layout plug-in 120-1 may determine where each node, including nodes 411, 414, and 415 should be located when output for presentation. Layout plug-in 120-1 may take into account the relationship between the nodes. For instance, execution of node 411 results in either node 414 or node 415 being executed next. Layout plug-in 120-1 may also determine routing for edges that illustrate the relationships between nodes. For instance, layout plug-in 120-1 may determine how edges 412 and 413 should be arranged to show the relationship between nodes 411, 414, and 415. The layout determined by layout plug-in 120-1 may then be used to present the nodes and edges to a user in the form illustrated in FIG. 4B.

FIG. 4C illustrates a bus chart 400C with each graphical node representing a computer system and links representing connections to a network. Such a visual representation may be useful to determine which computer systems are connected to a particular network within a corporate environment. Referring to FIG. 2, data visualization engine 110 may graphical create each node, including nodes 421, 422, and 423. Creation of each node may include creating the size of each node, the color of each node, the graphical image (e.g., a picture of a computer), the text, text size, and font of each node. Layout plug-in 120-1 may determine where each node, including nodes 421, 422, and 423 should be located when output for presentation. Layout plug-in 120-1 may take into account the relationship between the nodes. Layout plug-in 120-1 may also determine routing for edges that illustrate the relationships between nodes. For instance, layout plug-in 120-1 may determine how edges 424, 425, and 426 (which may be all considered a single edge) should be arranged to present the nodes connected with the edge in a visually pleasing and understandable manner. Node 421 is illustrated as having certain characteristics by colored blocks 427, which are represented by using different patterns. Node 421 may represent an abstraction of multiple interconnected computer systems indicated by expansion indication 428, selection of which may result in the subcomponents of node 421 being presented. The layout determined by layout plug-in 120-1 may then be used to present the nodes and edges to a user in the form illustrated in FIG. 4C.

FIG. 4D illustrates an arc chart 400D. Referring to FIG. 2, data visualization engine 110 may graphical create each node, including node 431. Creation of each node may include creating the size of each node, the color of each node, the associated text, text size, and font of each node. In FIG. 4D, different patterns on the nodes are used to represent different colors. Layout plug-in 120-1 may determine where each node, including nodes 431 and 433, should be located when output for presentation. As such, layout plug-in 120-1 may define the ordering of the nodes. Layout plug-in 120-1 may take into account the relationship between the nodes. A layout plug-in—may also determine routing for edges that illustrate the relationships between nodes. For instance, layout plug-in 120-1 may determine how edge 432 should be arranged to show the relationship between node 431 and node 433. For instance, a layout plug-in may determine the starting point and an equation to define the route for the arc of edge 432. The thickness of each edge may identify how closely two nodes are related or how frequently one node is accessed followed the other node. The layout determined by layout plug-in 120-1 may then be used to present the nodes and edges to a user in the form illustrated in FIG. 4D.

FIG. 4E illustrates a container chart with each graphical node representing, for example, a logical element. A data visualization engine may graphical create each node, including nodes 441, 442, and 443. Some nodes may be containers while other nodes are individual elements. Creation of each node may include creating the size of each node, the color of each node, the associated text, text size, and font of each node. A layout plug-in may determine where each node, including nodes 441, 442, and 443, should be located when output for presentation. As such, a layout plug-in may define the ordering of the nodes and how elements appear to be nested within containers. A layout plug-in may also determine routing for edges that illustrate the relationships between nodes. For instance, layout plug-in 120-1 may determine how edge 434 should be routed to show the relationship between two nodes. The layout determined by a layout plug-in may then be used to present the nodes and edges to a user in the form illustrated in the container chart of FIG. 4E.

FIG. 4F illustrates an embodiment of a circle chart 400F with each graphical node representing, for example, a person or item that is interrelated with one or more other persons or items. A data visualization engine may graphical create each node, including nodes 451 and 452. Creation of each node may include creating the size of each node, the color of each node, the associated text, text size, and font of each node. A layout plug-in may determine where each node, including nodes 451 and 452, should be located when output for presentation. As such, a layout plug-in may define the location of the nodes to create the circle and the ordering around the circle. A layout plug-in may also determine routing for edges that illustrate the relationships between nodes on the circle. For instance, a layout plug-in may determine how edge 453 should be routed to show the relationship between the two nodes it connects. The layout determined by a layout plug-in may then be used to present the nodes and edges to a user in the form illustrated in circle chart 400F of FIG. 4F.

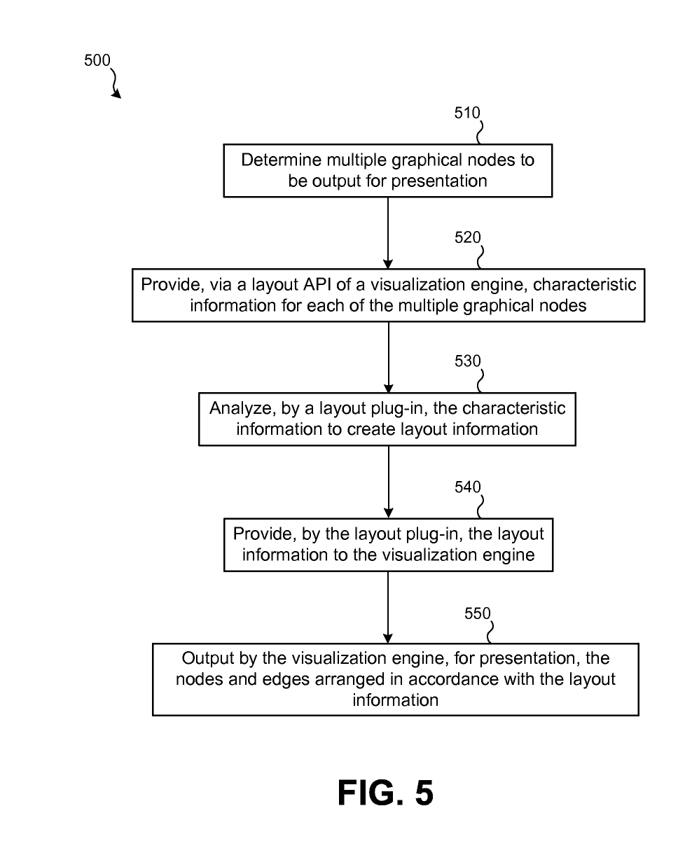

Various methods may be performed using the embodiments detailed in FIGS. 1-3, such as to create charts as detailed in relation to FIGS. 4A-4F. FIG. 5 illustrates an embodiment of a method 500 for using a layout plug-in as part of a data visualization system. Each step of method 500 may be performed using a computer system (which may include one or more individual computers) using hardware, firmware, and/or software. In some embodiments, each step may be performed by a single computerized device. In some embodiments, a cloud-based programming arrangement may be used to create an application using a programming language to perform method 500. Likewise, the cloud-based execution environment may be used to perform 500 such that the steps of method 500 are performed by a computer server remotely from a client device used by a user to interact with the computer server. For instance, the application may be executed via a web browser.

Prior to method 500 being performed, a developer may incorporate a data visualization software component into an application, while the application is under development (e.g., being programmed). The data visualization engine may be incorporated with a layout plug-in that is separate from the data visualization engine. The layout plug-in may be registered with the data visualization engine such that the data visualization engine is configured to rely on the layout plug-in for layout information in at least some situations. As such, the data visualization engine, when initially built, was distinct from the layout plug-in. Following registration, code for the application in which the data visualization engine and the plug-in layout are incorporated may be compiled. When the data visualization engine was incorporated into the application under development along with the registered layout plug-in, the data visualization engine was configured such that characteristic information about data to be visually presented is output to the layout plug-in (e.g., via a layout API). In response, the layout plug-in is configured to provide layout information to the data visualization engine. The developer has incorporated both the layout plug-in and the data visualization engine into the application that was developed. When the application is executed, the data visualization engine is configured to output for presentation data in accordance with a layout dictated by the layout plug-in.

At step 510, multiple graphical nodes may be determined. Determining such multiple graphical nodes may include receiving or otherwise accessing data to be represented by the nodes. Such nodes may be created such to be graphically presentable on a display to an end user. The data visualization engine may determine the size, shape, the coloring, the text, and/or interactive features available for each graphical node to be output for presentation. Notably, the data visualization engine may not determine a location for each graphical node for presentation.

At step 520, via a layout API, the data visualization engine may output characteristic information for each of the multiple graphical nodes that was determined at step 510. This characteristic information may be output to a layout plug-in that was previously registered with the data visualization engine. The characteristic information output at step 520 may indicate the relationships between the nodes as determined by the data visualization engine. The characteristic information output to the layout plug-in may be sufficient for the layout plug-in to determine where each node should be located and/or where links that indicate relationships between nodes should be located.

At step 530, the layout plug-in, may analyze the characteristic information received from the layout API to determine layout information for each graphical node and/or links between the nodes. The layout plug-in may only determine such layout information, such as in the form of coordinates or relative positions. At step 540, the layout plug-in may provide such layout information back to the visualization engine. In turn, the visualization engine may arrange the graphical nodes and/or links between the graphical nodes for presentation in accordance with the layout information provided by the layout plug-in. The visualization of the data may be output by the application having the visualization engine and the layout plug-in incorporated into its code for presentation by an end user at step 550. It should be understood that the layout plug-in provides functionality that was not initially built-in to the data visualization engine. By a developer registering a layout plug-in for use with a prebuilt visualization engine during development of the application, the developer can cause the prebuilt visualization engine that was incorporated into the application when it was compiled to output a visualization of data in accordance with a layout desired by the developer.

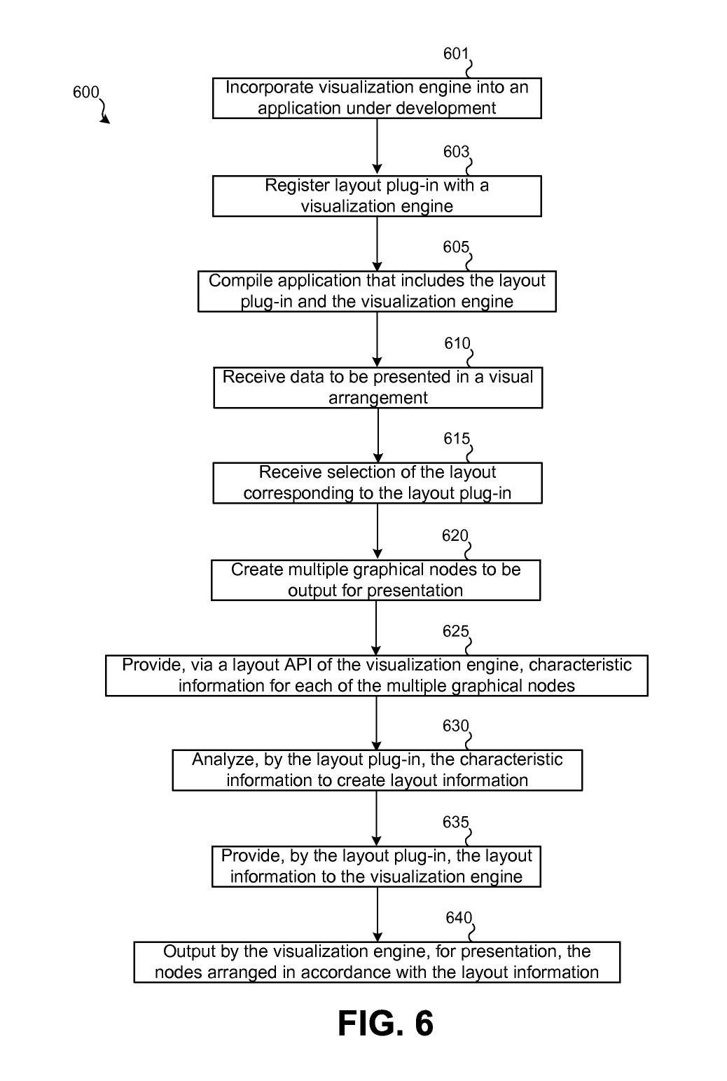

FIG. 6 illustrates another embodiment of a method 600 for using a layout plug-in as part of a data visualization system. Each step of method 600 may be performed using a computer system. In some embodiments, each step may be performed by a single computerized device. In some embodiments, a cloud-based programming arrangement may be used to create an application using a programming language to perform method 600 while another computer system may be used for executing the application. Likewise, a cloud-based execution environment may be used to perform method 600 such that the steps of method 600 are performed by a computer server remotely from a client device used by a user to interact with the computer server executing the application. For instance, the application may appear to a user to be executed via a web browser.

At step 601, a visualization engine, which may be a prebuilt piece of code (e.g., built by the entity providing the design environment being used to create an application or by some other developer) may be incorporated as part of an application under development. Such a prebuilt piece of code may be used to output a visualization of data that the application is configured to receive, access, and/or create. By a developer incorporating such a prebuilt visualization engine as part of the application under development, the developer may save himself from having to create from scratch code capable of outputting a visualization of data.

At step 603, during development of the application (or other piece of software), a layout plug-in to be used to determine the layout of graphical nodes is registered with a data visualization engine, which is incorporated as part of the code of an application. This application may be developed for use as a web-based application, which may be accessible by a user via a web browser with the application being executed by a remote server or by being executed by the web browser of the user. The application may be developed for use locally, such as by installing and using the application on a particular computer. Registration of the layout plug-in with the data visualization engine may be performed by a developer such that the layout plug-in is used to determine the layout of graphical nodes and edges to be output for presentation to a user.

At step 605, the application may be compiled. In addition to including at least one layout plug-in and the data visualization engine, the application may include one or more precoded software components and/or one or more custom software components. Further, the application may include one or more data storage arrangements or me be configured to access one or more data storage arrangements. The application may be compiled for execution to include such components. In some embodiments, steps 601 in 605 may be performed by a particular computer or computer system that is in use by developer of the application. Later steps of method 600 may be performed by some other computer system or by the same computer system on behalf of an end-user. It should be understood that steps 601 605 may serve as a standalone method for creating a application that can visually layout data in accordance with a layout plug-in.

At step 610, the data visualization engine of the application may receive data that is to be presented to a user visually. This data may be received by the data visualization engine in response to user input or some other triggering event causing data from within the application or external from the application to be passed to the data visualization engine to be put in a format appropriate to be output by the application for viewing by user. At step 615, in some embodiments, a user may select a format in which the data is to be presented. This selection may correspond to a particular layout plug-in. For example, in some embodiments, multiple layout plug-ins may be registered with the visualization engine. For instance, referring to FIG. 4A, a particular layout plug-in may be for laying out visualizations of an organization while another layout plug-in may be for laying out visualizations of a network, such as in FIG. 4C.

At step 620, multiple graphical nodes may be determined and created by the data visualization engine. These graphical nodes may be based on data provided to a data visualization engine. The data visualization engine may determine the size, shape, the coloring, the text, and/or interactive features available for each graphical node to be output for presentation.

At step 625, via a layout API, the data visualization engine may output characteristic information for each of the multiple graphical nodes that was determined at step 620. This characteristic information may be output to a layout plug-in that was registered with previously registered with the data visualization engine, selected at step 615, and is part of the compiled application (or is at least accessible by the application). The characteristic information output at step 625 may indicate the relationships between the nodes as determined by the data visualization engine. The characteristic information output to the layout plug-in may be sufficient for the layout plug-in to determine where each node should be located and/or where links (edges) that indicate relationships between nodes should be positioned and routed.

At step 630, the layout plug-in, may analyze the characteristic information received from the layout API to determine layout information for each graphical node and/or links (edges) between the nodes. The layout plug-in may only determine layout information, such as in the form of coordinates or relative positions. At step 635, the layout plug-in may provide such layout information back to the visualization engine. In turn, the visualization engine may arrange the graphical nodes and/or links between the graphical nodes for presentation in accordance with the layout information, which may include coordinates, provided by the layout plug-in.

At step 640, the data visualization engine may output for presentation such that the graphical nodes and links arranged in the layout dictated by the layout plug-in. Other (e.g., all other) characteristics of the graphical nodes and edges besides the layout may be determined by the data visualization engine.

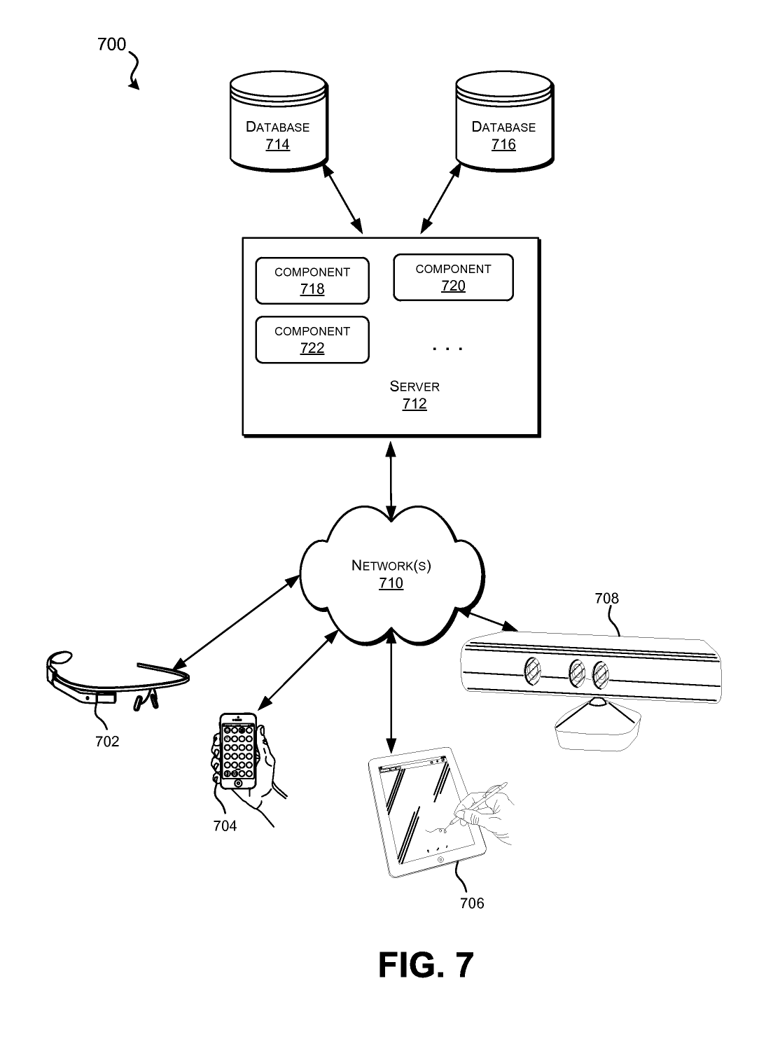

FIGS. 7-9 provide additional details on how a distributed system may be implemented that allows user and developers to remotely interact with a web service computer system, which may be used for development and/or execution of an application involving a data visualization engine and one or more layout plug-ins. FIG. 7 illustrates an embodiment of a distributed system 700 that permits the use of a remote developer (or user) computer system. In the illustrated embodiment, distributed system 700 includes one or more client computing devices 702, 704, 706, and 708 (which may represent user and/or developer computer systems), which are configured to execute and operate a client application such as a web browser, proprietary client (e.g., Oracle® Forms), or the like over one or more network(s) 710. Server 712 (which may be the web service computer system) may be communicatively coupled with remote client computing devices 702, 704, 706, and 708 via network 710.

In various embodiments, server 712 may be adapted to run one or more services or software applications provided by one or more of the components of the system. In some embodiments, these services may be offered as web-based or cloud services or under a Software as a Service (SaaS) model to the users of client computing devices 702, 704, 706, and/or 708. Users operating client computing devices 702, 704, 706, and/or 708 may in turn utilize one or more client applications to interact with server 712 to utilize the services provided by these components.

In the configuration depicted in the figure, the software components 718, 720 and 722 (which may represent a development environment for the application or an instance of the application executing) of distributed system 700 are shown as being implemented on server 712. In other embodiments, one or more of the components of distributed system 700 and/or the services provided by these components may also be implemented by one or more of the client computing devices 702, 704, 706, and/or 708. Users/developers operating the client computing devices may then utilize one or more client applications to use the services provided by these components. These components may be implemented in hardware, firmware, software, or combinations thereof. It should be appreciated that various different system configurations are possible, which may be different from distributed system 700. The embodiment shown in the figure is thus one example of a distributed system for implementing an embodiment system and is not intended to be limiting.

Client computing devices 702, 704, 706, and/or 708 may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 10, Palm OS, and the like, and being Internet, e-mail, short message service (SMS), Blackberry®, or other communication protocol enabled. The client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices 702, 704, 706, and 708 may be any other electronic device, such as a thin-client computer, an Internet-enabled gaming system (e.g., a Microsoft Xbox gaming console with or without a Kinect® gesture input device), and/or a personal messaging device, capable of communicating over network(s) 710.

Although exemplary distributed system 700 is shown with four client computing devices, any number of client computing devices may be supported. Other devices, such as devices with sensors, etc., may interact with server 712.

Network(s) 710 in distributed system 700 may be any type of network familiar to those skilled in the art that can support data communications using any of a variety of commercially-available protocols, including without limitation TCP/IP (transmission control protocol/Internet protocol), SNA (systems network architecture), IPX (Internet packet exchange), AppleTalk, and the like. Merely by way of example, network(s) 710 can be a local area network (LAN), such as one based on Ethernet, Token-Ring and/or the like. Network(s) 710 can be a wide-area network and the Internet. It can include a virtual network, including without limitation a virtual private network (VPN), an intranet, an extranet, a public switched telephone network (PSTN), an infra-red network, a wireless network (e.g., a network operating under any of the Institute of Electrical and Electronics (IEEE) 802.11 suite of protocols, Bluetooth®, and/or any other wireless protocol); and/or any combination of these and/or other networks.

Server 712 may be composed of one or more general purpose computers (e.g., it may be a distributed computing system), specialized server computers (including, by way of example, PC (personal computer) servers, UNIX® servers, mid-range servers, mainframe computers, rack-mounted servers, etc.), server farms, server clusters, or any other appropriate arrangement and/or combination. In various embodiments, server 712 may be adapted to run one or more services or software applications described in the foregoing disclosure. For example, server 712 may correspond to a server for performing processing described above according to an embodiment of the present disclosure.

Server 712 may run an operating system including any of those discussed above, as well as any commercially available server operating system. Server 712 may also run any of a variety of additional server applications and/or mid-tier applications, including HTTP (hypertext transport protocol) servers, FTP (file transfer protocol) servers, CGI (common gateway interface) servers, JAVA® servers, database servers, and the like. Exemplary database servers include without limitation those commercially available from Oracle, Microsoft, Sybase, IBM (International Business Machines), and the like.

In some implementations, server 712 may include one or more applications to analyze and consolidate data feeds and/or event updates received from users of client computing devices 702, 704, 706, and 708. As an example, data feeds and/or event updates may include, but are not limited to, Twitter® feeds, Facebook® updates or real-time updates received from one or more third party information sources and continuous data streams, which may include real-time events related to sensor data applications, financial tickers, network performance measuring tools (e.g., network monitoring and traffic management applications), clickstream analysis tools, automobile traffic monitoring, and the like. Server 712 may also include one or more applications to display the data feeds and/or real-time events via one or more display devices of client computing devices 702, 704, 706, and 708.

Distributed system 700 may also include one or more databases 714 and 716. Databases 714 and 716 may reside in a variety of locations. By way of example, one or more of databases 714 and 716 may reside on a non-transitory storage medium local to (and/or resident in) server 712. Alternatively, databases 714 and 716 may be remote from server 712 and in communication with server 712 via a network-based or dedicated connection. In one set of embodiments, databases 714 and 716 may reside in a storage-area network (SAN). Similarly, any necessary files for performing the functions attributed to server 712 may be stored locally on server 712 and/or remotely, as appropriate. In one set of embodiments, databases 714 and 716 may include relational databases, such as databases provided by Oracle®, that are adapted to store, update, and retrieve data in response to SQL-formatted commands.

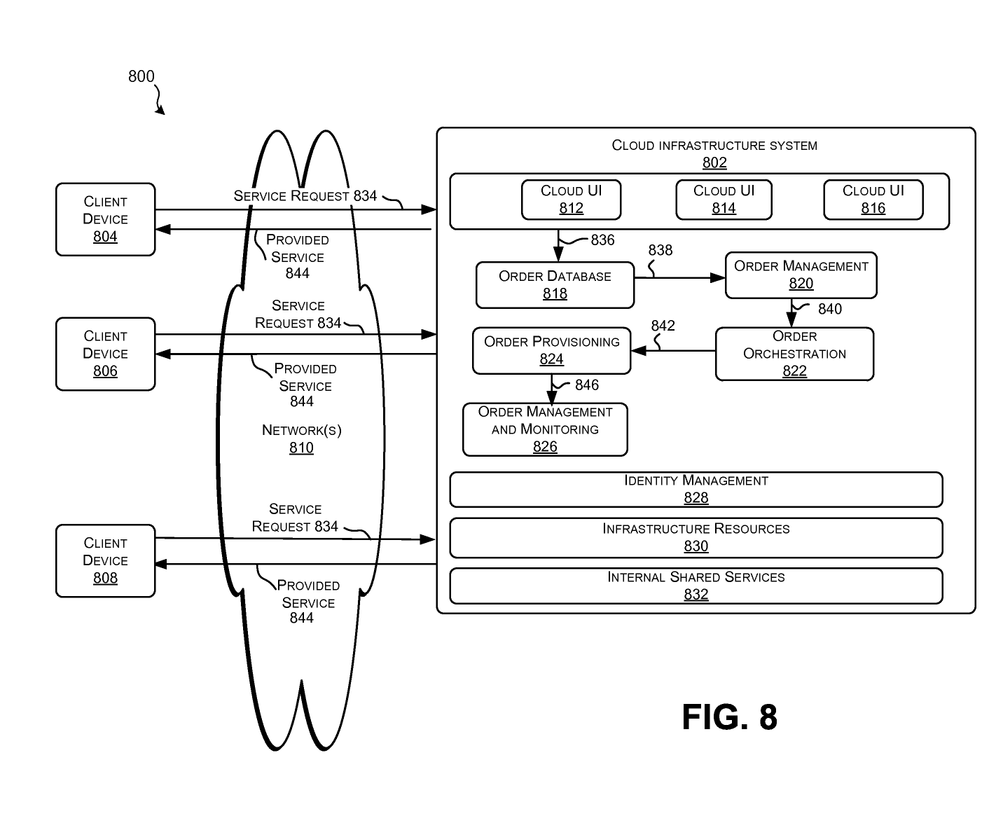

FIG. 8 is a simplified block diagram of one or more components of a cloud infrastructure system 800 by which services provided by one or more components of an embodiment system may be offered as cloud services, in accordance with an embodiment of the present disclosure. In the illustrated embodiment, cloud infrastructure system 800 includes one or more client computing devices 804, 806, and 808 that may be used by users to interact with a cloud infrastructure system 802 that provides cloud services. The client computing devices may be configured to operate a client application such as a web browser, a proprietary client application (e.g., Oracle® Forms), or some other application, which may be used by a user of the client computing device to interact with cloud infrastructure system 802 to use services provided by cloud infrastructure system 802.

It should be appreciated that cloud infrastructure system 802 depicted in the figure may have other components than those depicted. Further, the embodiment shown in the figure is only one example of a cloud infrastructure system that may incorporate an embodiment of the invention. In some other embodiments, cloud infrastructure system 802 may have more or fewer components than shown in the figure, may combine two or more components, or may have a different configuration or arrangement of components.

Although exemplary cloud infrastructure system 800 is shown with three client computing devices, any number of client computing devices may be supported. Other devices such as devices with sensors, etc. may interact with cloud infrastructure system 802.

Network(s) 810 may facilitate communications and exchange of data between client computing devices 804, 806, and 808 and cloud infrastructure system 802. Each network may be any type of network familiar to those skilled in the art that can support data communications using any of a variety of commercially-available protocols. Cloud infrastructure system 802 may comprise one or more computers and/or servers.

In certain embodiments, services provided by the cloud infrastructure system may include a host of services that are made available to users of the cloud infrastructure system on demand, such as online data storage and backup solutions, Web-based e-mail services, hosted office suites and document collaboration services, database processing, managed technical support services, and the like. Services provided by the cloud infrastructure system can dynamically scale to meet the needs of its users. A specific instantiation of a service provided by cloud infrastructure system is referred to herein as a “service instance.” In general, any service made available to a user via a communication network, such as the Internet, from a cloud service provider's system is referred to as a “cloud service.” Typically, in a public cloud environment, servers and systems that make up the cloud service provider's system are different from the customer's own on-premises servers and systems. For example, a cloud service provider's system may host an application, and a user may, via a communication network such as the Internet, on demand, order and use the application.

In some examples, a service in a computer network cloud infrastructure may include protected computer network access to storage, a hosted database, a hosted web server, a software application, or other service provided by a cloud vendor to a user, or as otherwise known in the art. For example, a service can include password-protected access to remote storage on the cloud through the Internet. As another example, a service can include a web service-based hosted relational database and a script-language middleware engine for private use by a networked developer. As another example, a service can include access to an email software application hosted on a cloud vendor's web site.

In certain embodiments, cloud infrastructure system 802 may include a suite of applications, middleware, and database service offerings that are delivered to a customer in a self-service, subscription-based, elastically scalable, reliable, highly available, and secure manner. An example of such a cloud infrastructure system is the Oracle Public Cloud provided by the present assignee.

In various embodiments, cloud infrastructure system 802 may be adapted to automatically provision, manage and track a customer's subscription to services offered by cloud infrastructure system 802. Cloud infrastructure system 802 may provide the cloud services via different deployment models. For example, services may be provided under a public cloud model in which cloud infrastructure system 802 is owned by an organization selling cloud services (e.g., owned by Oracle®) and the services are made available to the general public or different industry enterprises. As another example, services may be provided under a private cloud model in which cloud infrastructure system 802 is operated solely for a single organization and may provide services for one or more entities within the organization. The cloud services may also be provided under a community cloud model in which cloud infrastructure system 802 and the services provided by cloud infrastructure system 802 are shared by several organizations in a related community. The cloud services may also be provided under a hybrid cloud model, which is a combination of two or more different models.

In some embodiments, the services provided by cloud infrastructure system 802 may include one or more services provided under Software as a Service (SaaS) category, Platform as a Service (PaaS) category, Infrastructure as a Service (IaaS) category, or other categories of services including hybrid services. A customer, via a subscription order, may order one or more services provided by cloud infrastructure system 802. Cloud infrastructure system 802 then performs processing to provide the services in the customer's subscription order.

In some embodiments, the services provided by cloud infrastructure system 802 may include, without limitation, application services, platform services and infrastructure services. In some examples, application services may be provided by the cloud infrastructure system via a SaaS platform. The SaaS platform may be configured to provide cloud services that fall under the SaaS category. For example, the SaaS platform may provide capabilities to build and deliver a suite of on-demand applications on an integrated development and deployment platform. The SaaS platform may manage and control the underlying software and infrastructure for providing the SaaS services. By utilizing the services provided by the SaaS platform, customers can utilize applications executing on the cloud infrastructure system. Customers can acquire the application services without the need for customers to purchase separate licenses and support. Various different SaaS services may be provided. Examples include, without limitation, services that provide solutions for sales performance management, enterprise integration, and business flexibility for large organizations.

In some embodiments, platform services may be provided by the cloud infrastructure system via a PaaS platform. The PaaS platform may be configured to provide cloud services that fall under the PaaS category. Examples of platform services may include without limitation services that enable organizations (such as Oracle) to consolidate existing applications on a shared, common architecture, as well as the ability to build new applications that leverage the shared services provided by the platform. The PaaS platform may manage and control the underlying software and infrastructure for providing the PaaS services. Customers can acquire the PaaS services provided by the cloud infrastructure system without the need for customers to purchase separate licenses and support. Examples of platform services include, without limitation, Oracle Java Cloud Service (JCS), Oracle Database Cloud Service (DBCS), and others.

By utilizing the services provided by the PaaS platform, customers can employ programming languages and tools supported by the cloud infrastructure system and also control the deployed services. In some embodiments, platform services provided by the cloud infrastructure system may include database cloud services, middleware cloud services (e.g., Oracle Fusion Middleware services), and Java cloud services. In one embodiment, database cloud services may support shared service deployment models that enable organizations to pool database resources and offer customers a Database as a Service in the form of a database cloud. Middleware cloud services may provide a platform for customers to develop and deploy various business applications, and Java cloud services may provide a platform for customers to deploy Java applications, in the cloud infrastructure system.

Various different infrastructure services may be provided by an IaaS platform in the cloud infrastructure system. The infrastructure services facilitate the management and control of the underlying computing resources, such as storage, networks, and other fundamental computing resources for customers utilizing services provided by the SaaS platform and the PaaS platform.

In certain embodiments, cloud infrastructure system 802 may also include infrastructure resources 830 for providing the resources used to provide various services to customers of the cloud infrastructure system. In one embodiment, infrastructure resources 830 may include pre-integrated and optimized combinations of hardware, such as servers, storage, and networking resources to execute the services provided by the PaaS platform and the SaaS platform.

In some embodiments, resources in cloud infrastructure system 802 may be shared by multiple users and dynamically re-allocated per demand. Additionally, resources may be allocated to users in different time zones. For example, cloud infrastructure system 830 may enable a first set of users in a first time zone to utilize resources of the cloud infrastructure system for a specified number of hours and then enable the re-allocation of the same resources to another set of users located in a different time zone, thereby maximizing the utilization of resources.

In certain embodiments, a number of internal shared services 832 may be provided that are shared by different components or modules of cloud infrastructure system 802 and by the services provided by cloud infrastructure system 802. These internal shared services may include, without limitation, a security and identity service, an integration service, an enterprise repository service, an enterprise manager service, a virus scanning and white list service, a high availability, backup and recovery service, service for enabling cloud support, an email service, a notification service, a file transfer service, and the like.

In certain embodiments, cloud infrastructure system 802 may provide comprehensive management of cloud services (e.g., SaaS, PaaS, and IaaS services) in the cloud infrastructure system. In one embodiment, cloud management functionality may include capabilities for provisioning, managing and tracking a customer's subscription received by cloud infrastructure system 802, and the like.

In one embodiment, as depicted in the figure, cloud management functionality may be provided by one or more modules, such as an order management module 820, an order orchestration module 822, an order provisioning module 824, an order management and monitoring module 826, and an identity management module 828. These modules may include or be provided using one or more computers and/or servers, which may be general purpose computers, specialized server computers, server farms, server clusters, or any other appropriate arrangement and/or combination.

In exemplary operation 834, a customer using a client device, such as client computing devices 804, 806, or 808, may interact with cloud infrastructure system 802 by requesting one or more services provided by cloud infrastructure system 802 and placing an order for a subscription for one or more services offered by cloud infrastructure system 802, such as execution of an application or a integrated development environment. In certain embodiments, the customer may access a cloud User Interface (UI), cloud UI 812, cloud UI 814 and/or cloud UI 816 and place a subscription order via these UIs. The order information received by cloud infrastructure system 802 in response to the customer placing an order may include information identifying the customer and one or more services offered by the cloud infrastructure system 802 that the customer intends to subscribe to.

After an order has been placed by the customer, the order information is received via the cloud UIs, 812, 814 and/or 816. At operation 836, the order is stored in order database 818. Order database 818 can be one of several databases operated by cloud infrastructure system 800 and operated in conjunction with other system elements.

At operation 838, the order information is forwarded to an order management module 820. In some instances, order management module 820 may be configured to perform billing and accounting functions related to the order, such as verifying the order, and upon verification, booking the order.

At operation 840, information regarding the order is communicated to an order orchestration module 822. Order orchestration module 822 may utilize the order information to orchestrate the provisioning of services and resources for the order placed by the customer. In some instances, order orchestration module 822 may orchestrate the provisioning of resources to support the subscribed services using the services of order provisioning module 824.

In certain embodiments, order orchestration module 822 enables the management of business processes associated with each order and applies business logic to determine whether an order should proceed to provisioning. At operation 842, upon receiving an order for a new subscription, order orchestration module 822 sends a request to order provisioning module 824 to allocate resources and configure those resources needed to fulfill the subscription order. Order provisioning module 824 enables the allocation of resources for the services ordered by the customer. Order provisioning module 824 provides a level of abstraction between the cloud services provided by cloud infrastructure system 800 and the physical implementation layer that is used to provision the resources for providing the requested services. Order orchestration module 822 may thus be isolated from implementation details, such as whether or not services and resources are actually provisioned on the fly or pre-provisioned and only allocated/assigned upon request.

At operation 844, once the services and resources are provisioned, a notification of the provided service may be sent to customers on client computing devices 804, 806 and/or 808 by order provisioning module 824 of cloud infrastructure system 802.

At operation 846, the customer's subscription order may be managed and tracked by an order management and monitoring module 826. In some instances, order management and monitoring module 826 may be configured to collect usage statistics for the services in the subscription order, such as the amount of storage used, the amount data transferred, the number of users, and the amount of system up time and system down time.

In certain embodiments, cloud infrastructure system 800 may include an identity management module 828. Identity management module 828 may be configured to provide identity services, such as access management and authorization services in cloud infrastructure system 800. In some embodiments, identity management module 828 may control information about customers who wish to utilize the services provided by cloud infrastructure system 802. Such information can include information that authenticates the identities of such customers and information that describes which actions those customers are authorized to perform relative to various system resources (e.g., files, directories, applications, communication ports, memory segments, etc.) Identity management module 828 may also include the management of descriptive information about each customer and about how and by whom that descriptive information can be accessed and modified.

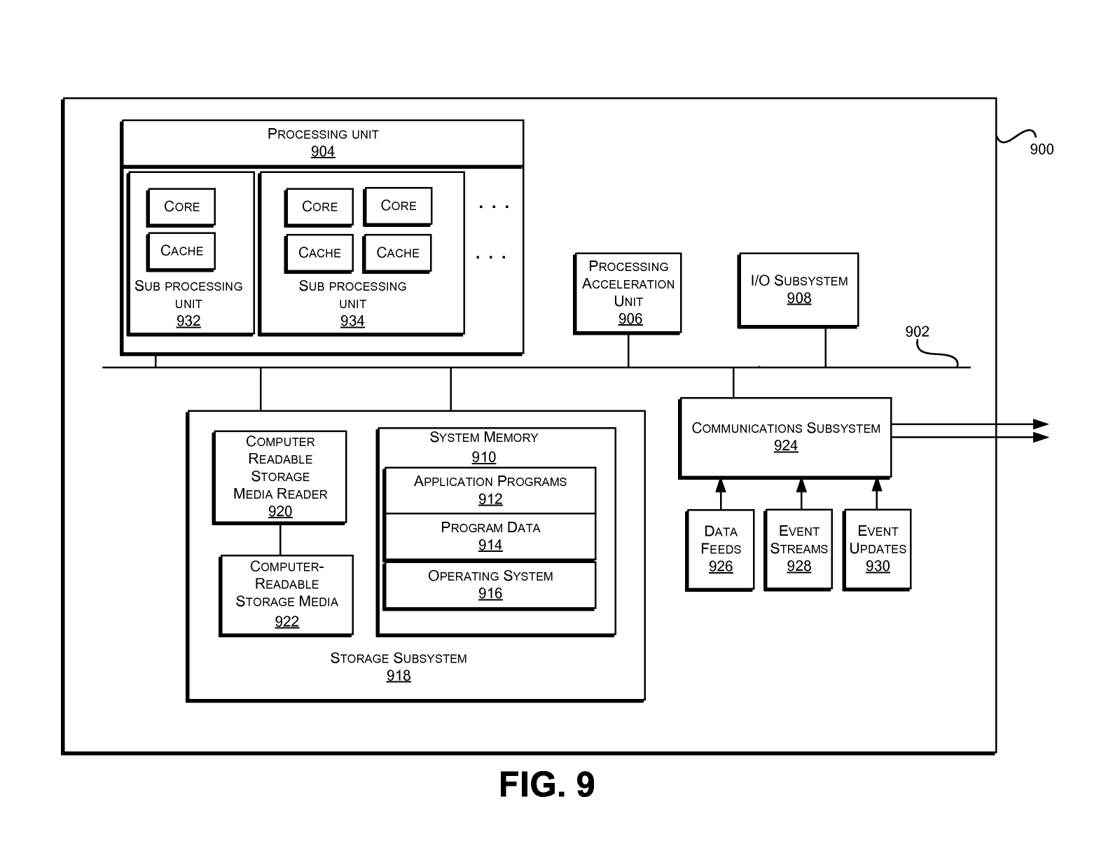

FIG. 9 illustrates an exemplary computer system 900, in which various embodiments of the present invention may be implemented. Computer system 900 may be used to implement any of the computer systems described above, such as client computer systems, server systems, cloud host systems, etc. Specifically, one or more instances of computer system 900 may be used to execute development of an application and execution of an application that includes a data visualization engine and one or more layout plug-ins. As shown in FIG. 9, computer system 900 includes a processing unit 904 that communicates with a number of peripheral subsystems via a bus subsystem 902. These peripheral subsystems may include a processing acceleration unit 906, an I/O subsystem 908, a storage subsystem 918 and a communications subsystem 924. Storage subsystem 918 includes tangible (non-transitory) computer-readable storage media 922 and a system memory 910. One or more instances of computer system 900 may be used to perform the methods described herein and/or execute any of the software systems previously detailed.

Bus subsystem 902 provides a mechanism for letting the various components and subsystems of computer system 900 communicate with each other as intended. Although bus subsystem 902 is shown schematically as a single bus, alternative embodiments of the bus subsystem may utilize multiple buses. Bus subsystem 902 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 904, which can be implemented as one or more integrated circuits (e.g., a conventional microprocessor or microcontroller), controls the operation of computer system 900. One or more processors may be included in processing unit 904. These processors may include single core or multicore processors. In certain embodiments, processing unit 904 may be implemented as one or more independent processing units 932 and/or 934 with single or multicore processors included in each processing unit. In other embodiments, processing unit 904 may also be implemented as a quad-core processing unit formed by integrating two dual-core processors into a single chip.

In various embodiments, processing unit 904 can execute a variety of programs in response to program code and can maintain multiple concurrently executing programs or processes. At any given time, some or all of the program code to be executed can be resident in processor(s) 904 and/or in storage subsystem 918. Through suitable programming, processor(s) 904 can provide various functionalities described above. Computer system 900 may additionally include a processing acceleration unit 906, which can include a digital signal processor (DSP), a special-purpose processor, and/or the like.

I/O subsystem 908 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Ski® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 900 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 900 may comprise a storage subsystem 918 that comprises software elements, shown as being currently located within a system memory 910. System memory 910 may store program instructions that are loadable and executable on processing unit 904, as well as data generated during the execution of these programs.

Depending on the configuration and type of computer system 900, system memory 910 may be volatile (such as random access memory (RAM)) and/or non-volatile (such as read-only memory (ROM), flash memory, etc.) The RAM typically contains data and/or program modules that are immediately accessible to and/or presently being operated and executed by processing unit 904. In some implementations, system memory 910 may include multiple different types of memory, such as static random access memory (SRAM) or dynamic random access memory (DRAM). In some implementations, a basic input/output system (BIOS), containing the basic routines that help to transfer information between elements within computer system 900, such as during start-up, may typically be stored in the ROM. By way of example, and not limitation, system memory 910 also illustrates application programs 912, which may include client applications, Web browsers, mid-tier applications, relational database management systems (RDBMS), etc., program data 914, and an operating system 916. By way of example, operating system 916 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry®9 OS, and Palm® OS operating systems.

Storage subsystem 918 may also provide a tangible computer-readable storage medium for storing the basic programming and data constructs that provide the functionality of some embodiments. Software (programs, code modules, instructions) that when executed by a processor provide the functionality described above may be stored in storage subsystem 918. These software modules or instructions may be executed by processing unit 904. Storage subsystem 918 may also provide a repository for storing data used in accordance with the present invention.

Storage subsystem 918 may also include a computer-readable storage media reader 920 that can further be connected to computer-readable storage media 922. Together and, optionally, in combination with system memory 910, computer-readable storage media 922 may comprehensively represent remote, local, fixed, and/or removable storage devices plus storage media for temporarily and/or more permanently containing, storing, transmitting, and retrieving computer-readable information.

Computer-readable storage media 922 containing code, or portions of code, can also include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media. This can also include nontangible computer-readable media, such as data signals, data transmissions, or any other medium which can be used to transmit the desired information and which can be accessed by computing system 900.

By way of example, computer-readable storage media 922 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 922 may include, but is not limited to, Zip® drives, flash memory cards, universal serial bus (USB) flash drives, secure digital (SD) cards, DVD disks, digital video tape, and the like. Computer-readable storage media 922 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 900.

Communications subsystem 924 provides an interface to other computer systems and networks. Communications subsystem 924 serves as an interface for receiving data from and transmitting data to other systems from computer system 900. For example, communications subsystem 924 may enable computer system 900 to connect to one or more devices via the Internet. In some embodiments, communications subsystem 924 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof), global positioning system (GPS) receiver components, and/or other components. In some embodiments, communications subsystem 924 can provide wired network connectivity (e.g., Ethernet) in addition to or instead of a wireless interface.

In some embodiments, communications subsystem 924 may also receive input communication in the form of structured and/or unstructured data feeds 926, event streams 928, event updates 930, and the like on behalf of one or more users who may use computer system 900.

By way of example, communications subsystem 924 may be configured to receive data feeds 926 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 924 may also be configured to receive data in the form of continuous data streams, which may include event streams 928 of real-time events and/or event updates 930, that may be continuous or unbounded in nature with no explicit end. Examples of applications that generate continuous data may include, for example, sensor data applications, financial tickers, network performance measuring tools (e.g. network monitoring and traffic management applications), clickstream analysis tools, automobile traffic monitoring, and the like.

Communications subsystem 924 may also be configured to output the structured and/or unstructured data feeds 926, event streams 928, event updates 930, and the like to one or more databases that may be in communication with one or more streaming data source computers coupled to computer system 900.

Computer system 900 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 700 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Also, configurations may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of steps may be undertaken before, during, or after the above elements are considered.

What is claimed is:

1. A method for incorporating data visualization capabilities into an application, the method comprising:
incorporating, by a computer system, a prebuilt visualization component into an application under development, wherein the prebuilt visualization component is configured to create graphical nodes to be arranged and output for presentation by the application following compilation;
registering, by the computer system, a layout plug-in with the prebuilt visualization component such that the prebuilt visualization component communicates with the layout plug-in, wherein
the layout plug-in is configured to arrange the graphical nodes such that the graphical nodes created by the prebuilt visualization component are arranged by the layout plug-in following compilation; and
compiling, by the computer system, the application such that the application is compiled to include the prebuilt visualization component and the registered layout plug-in.

2. The method for incorporating data visualization capabilities into the application of claim 1, the method further comprising:
following compilation, executing, by the computer system, the application;
receiving, by the application being executed by the computer system, data to be visualized;
creating, by the prebuilt visualization component being executed by the computer system as part of the application, a plurality of graphical nodes based on the data; and
determining, by the layout plug-in being executed by the computer system as part of the application, a plurality of locations for the plurality of graphical nodes.

3. The method for incorporating data visualization capabilities into the application of claim 2, the method further comprising:
providing, by the layout plug-in being executed by the computer system to the prebuilt visualization component, a set of coordinates indicative of the plurality of locations for the plurality of graphical nodes.

4. The method for incorporating data visualization capabilities into the application of claim 3, the method further comprising:
outputting, by the application being executed by the computer system, to a presentation device, a data visualization representing the data as the plurality of graphical nodes arranged based on the plurality of locations.

5. The method for incorporating data visualization capabilities into the application of claim 3, the method further comprising:
providing, by the prebuilt visualization component being executed by the computer system to the layout plug-in, characteristic information for each node of the plurality of graphical nodes.

6. The method for incorporating data visualization capabilities into the application of claim 3, the method further comprising:
arranging, by the layout plug-in being executed by the computer system as part of the application, a plurality of edges, wherein each edge connects at least two graphical nodes of the plurality of graphical nodes.

7. The method for incorporating data visualization capabilities into the application of claim 2, the method further comprising:
receiving, by the application being executed by the computer system, a selection of a graphical layout style, wherein:
the graphical layout style selected corresponds to the layout plug-in; and
the layout plug-in is used to determine a location of graphical nodes at least partially based on the selection of the graphical layout style.

8. A system for incorporating data visualization capabilities into an application, the system comprising:
one or more processors; and
a memory communicatively coupled with and readable by the one or more processors and having stored therein processor-readable instructions which, when executed by the one or more processors, cause the one or more processors to:
incorporate a prebuilt visualization component into an application under development, wherein the prebuilt visualization component is configured to create graphical nodes to be arranged and output for presentation by the application following compilation;
register a layout plug-in with the prebuilt visualization component such that the prebuilt visualization component communicates with the layout plug-in, wherein
the layout plug-in is configured to arrange the graphical nodes such that the graphical nodes created by the prebuilt visualization component are arranged by the layout plug-in following compilation; and
compile the application such that the application is compiled to include the prebuilt visualization component and the registered layout plug-in.

9. The system for incorporating data visualization capabilities into the application of claim 8, wherein the processor-readable instructions, when executed, further cause the one or more processors to:
execute the application following compilation;
receive, by the application being executed, data to be visualized;
create, by the prebuilt visualization component being executed as part of the application, a plurality of graphical nodes based on the data; and
determine, by the layout plug-in being executed as part of the application, a plurality of locations for the plurality of graphical nodes.

10. The system for incorporating data visualization capabilities into the application of claim 9, wherein the processor-readable instructions, when executed, further cause the one or more processors to:
provide, by the layout plug-in being executed to the prebuilt visualization component, a set of coordinates indicative of the plurality of locations for the plurality of graphical nodes.

11. The system for incorporating data visualization capabilities into the application of claim 10, wherein the processor-readable instructions, when executed, further cause the one or more processors to:
output, by the application being executed, to a presentation device, a data visualization representing the data as the plurality of graphical nodes arranged based on the plurality of locations.

12. The system for incorporating data visualization capabilities into the application of claim 10, wherein the processor-readable instructions, when executed, further cause the one or more processors to:
provide, by the prebuilt visualization component being executed, to the layout plug-in, characteristic information for each node of the plurality of graphical nodes.

13. The system for incorporating data visualization capabilities into the application of claim 10, wherein the processor-readable instructions, when executed, further cause the one or more processors to:
arrange, by the layout plug-in being executed as part of the application, a plurality of edges, wherein each edge connects at least two graphical nodes of the plurality of graphical nodes.

14. The system for incorporating data visualization capabilities into the application of claim 9, wherein the processor-readable instructions, when executed, further cause the one or more processors to:
receive, by the application being executed, a selection of a graphical layout style, wherein:
the graphical layout style selected corresponds to the layout plug-in; and
the layout plug-in is used to determine a location of graphical nodes at least partially based on the selection of the graphical layout style.

15. A non-transitory processor-readable medium for incorporating data visualization capabilities into an application, comprising processor-readable instructions configured to cause one or more processors to:
incorporate a prebuilt visualization component into an application under development, wherein the prebuilt visualization component is configured to create graphical nodes to be arranged and output for presentation by the application following compilation;
register a layout plug-in with the prebuilt visualization component such that the prebuilt visualization component communicates with the layout plug-in, wherein
the layout plug-in is configured to arrange the graphical nodes such that the graphical nodes created by the prebuilt visualization component are arranged by the layout plug-in following compilation; and
compile the application such that the application is compiled to include the prebuilt visualization component and the registered layout plug-in.

16. The non-transitory processor-readable medium for incorporating data visualization capabilities into the application of claim 15, wherein the processor-readable instructions are further configured to cause the one or more processors to:
execute the application following compilation;
receive, by the application being executed, data to be visualized;
create, by the prebuilt visualization component being executed as part of the application, a plurality of graphical nodes based on the data; and
determine, by the layout plug-in being executed as part of the application, a plurality of locations for the plurality of graphical nodes.

17. The non-transitory processor-readable medium for incorporating data visualization capabilities into the application of claim 16, wherein the processor-readable instructions are further configured to cause the one or more processors to:
provide, by the layout plug-in being executed to the prebuilt visualization component, a set of coordinates indicative of the plurality of locations for the plurality of graphical nodes.

18. The non-transitory processor-readable medium for incorporating data visualization capabilities into the application of claim 17, wherein the processor-readable instructions are further configured to cause the one or more processors to:
output, by the application being executed, to a presentation device, a data visualization representing the data as the plurality of graphical nodes arranged based on the plurality of locations.

19. The non-transitory processor-readable medium for incorporating data visualization capabilities into the application of claim 17, wherein the processor-readable instructions are further configured to cause the one or more processors to:
provide, by the prebuilt visualization component being executed, to the layout plug-in, characteristic information for each node of the plurality of graphical nodes.

20. The non-transitory processor-readable medium for incorporating data visualization capabilities into the application of claim 17, wherein the processor-readable instructions are further configured to cause the one or more processors to:
arrange, by the layout plug-in being executed as part of the application, a plurality of edges, wherein each edge connects at least two graphical nodes of the plurality of graphical nodes.
